(19) United States
(12) Patent Application Publication
(10) Pub. No.: US 2015/0032839 A1
(43) Pub. Date: Jan. 29, 2015

(54) SYSTEMS AND METHODS FOR MANAGING STORAGE NETWORK DEVICES

(71) Applicant: NetApp, Inc., Sunnyvale, CA (US)

(72) Inventors: Sergey Serokurov, Milpitas, CA (US); Stephanie He, Fremont, CA (US); Dennis Ramdass, Mountain View, CA (US)

(73) Assignee: NetApp, Inc., Sunnyvale, CA (US)

(21) Appl. No.: 13/952,108

(22) Filed: Jul. 26, 2013

(51) Int. Cl. H04L 29/08

(52) U.S. Cl. CPC H04L 67/1031; H04L 67/1097
USPC 709/214

(57) ABSTRACT

Systems and methods for managing storage entities in a storage network are provided. Embodiments may provide a group of management devices to manage a plurality of storage entities in the storage network. In some instances, a storage entity hierarchy for the plurality of storage entities may be identified. At least one of a load or a health associated with a management device of the group of management devices may, in embodiments, be determined. In some embodiments, the plurality of storage entities may be managed in accordance with the identified storage entity hierarchy and based, at least in part, on the determined at least one of a load or a health.

### TECHNICAL FIELD

The present application relates generally to storage networks and, more particularly, to management and monitoring of storage entities in a storage network.

### BACKGROUND OF THE INVENTION

The creation and storage of digitized data has proliferated in recent years. Accordingly, techniques and mechanisms that facilitate efficient and cost effective storage of large amounts of digital data are common today. For example, a cluster network environment of nodes may be implemented as a data storage system to facilitate the creation, storage, retrieval, and/or processing of digital data. Such a data storage system may be implemented using a variety of storage architectures, such as a network-attached storage (NAS) environment, a storage area network (SAN), a direct-attached storage environment, and combinations thereof. The foregoing data storage systems may comprise one or more data storage entities configured to store digital data within data volumes.

Whereas the primary storage entity in a storage system cluster used to be a physical storage entity, such as a disk drive, a solid state drive, etc., recent trends have seen a rise in the number of virtual storage entities, such as storage systems that run on virtual machines with no specific hardware to support them, included in a storage system cluster. The addition of virtual storage entities increases the overall number of storage entities in the storage system cluster that must be managed. As a result, managing and monitoring an increasing number of storage entities has become a non-trivial task, as detailed below.

Conventional storage systems typically include a management server that is tasked with managing a designated storage system cluster. The management server is typically a computer within a storage management platform that monitors different objects. One such storage management platform is the System Center Operations Manager (SCOM) developed by Microsoft Corporation, although other storage management platforms are also available. In conventional systems, a storage system cluster with storage entities, either physical or virtual, is managed by only one management server within the storage management platform. Therefore, even though the storage management platform may include multiple management servers, a storage system cluster is managed by only one management server.

Many disadvantages are associated with these conventional systems. For example, if a management server becomes inoperable or is in need of an upgrade, a user must manually take down the inoperable management server, and must manually designate another management server to manage the storage entities that were previously being managed by the inoperable management server. In some situations, if a management server unsuspectingly becomes inoperable, all the data being monitored by the management server may be lost.

Other disadvantages associated with the convention systems are becoming apparent as a result of the increasing number of storage entities that a management server must manage. For example, because storage system clusters in conventional systems can only be managed by one management server, and because more and more virtual storage entities are being added to storage system clusters, an increasing number of conventional management server systems are reaching their maximum management load capacity.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating a storage system in accordance with an embodiment of the present disclosure;

FIG. 2 is a block diagram illustrating a storage system in accordance with an embodiment of the present disclosure;

FIG. 3 is a block diagram illustrating a storage entity hierarchy in accordance with an embodiment of the present disclosure; and

FIG. 4 is a schematic flow chart diagram illustrating an example process flow for a method in accordance with an embodiment of the present disclosure.

### DETAILED DESCRIPTION OF THE INVENTION

In embodiments, systems and methods are operable to deploy a group, which includes at least two management devices, to manage a plurality of storage entities in the storage network. Each management device of the group may have access to a shared management database. In operation according to embodiments, the storage entities may be managed by any one management device of the group. The systems may also be operable to identify a storage entity hierarchy for the plurality of storage entities. The systems may be further operable to determine at least one of a load or a health associated with a first management device of the group of management devices. The systems may also be operable to manage the plurality of storage entities with the group of management devices in accordance with the identified storage entity hierarchy and based, at least in part, on the determined at least one of a load or a health. In embodiments, managing the plurality of storage entities may include distributing the management of the plurality of storage entities across the group of management devices. Furthermore, the systems of embodiments may redistribute the management of the plurality of storage entities across the group of management devices based on the determined at least one of a load and health associated with at the first management device of the group. By managing the plurality of storage entities with a group of management devices, the robustness of systems in embodiments may be increased because more management devices are available to manage a storage entity. Other features and modifications can be added and made to the systems and methods described herein without departing from the scope of the disclosure.

In embodiments, systems and methods are operable to deploy a group, which includes at least two management devices, to manage a plurality of storage entities in the storage network. Each management device of the group may have access to a shared management database. In operation according to embodiments, the storage entities may be managed by any one management device of the group. The systems may also be operable to identify a storage entity hierarchy for the plurality of storage entities. The systems may be further operable to determine at least one of a load or a health associated with a first management device of the group of management devices. The systems may also be operable to manage the plurality of storage entities with the group of management devices in accordance with the identified storage entity hierarchy and based, at least in part, on the determined at least one of a load or a health. In embodiments, managing the plurality of storage entities may include distributing the management of the plurality of storage entities across the group of management devices. Furthermore, the systems of embodiments may redistribute the management of the plurality of storage entities across the group of management devices based on the determined at least one of a load and health associated with at the first management device of the group. By managing the plurality of storage entities with a group of management devices, the robustness of systems in embodiments may be increased because more management devices are available to manage a storage entity. Other features and modifications can be added and made to the systems and methods described herein without departing from the scope of the disclosure.

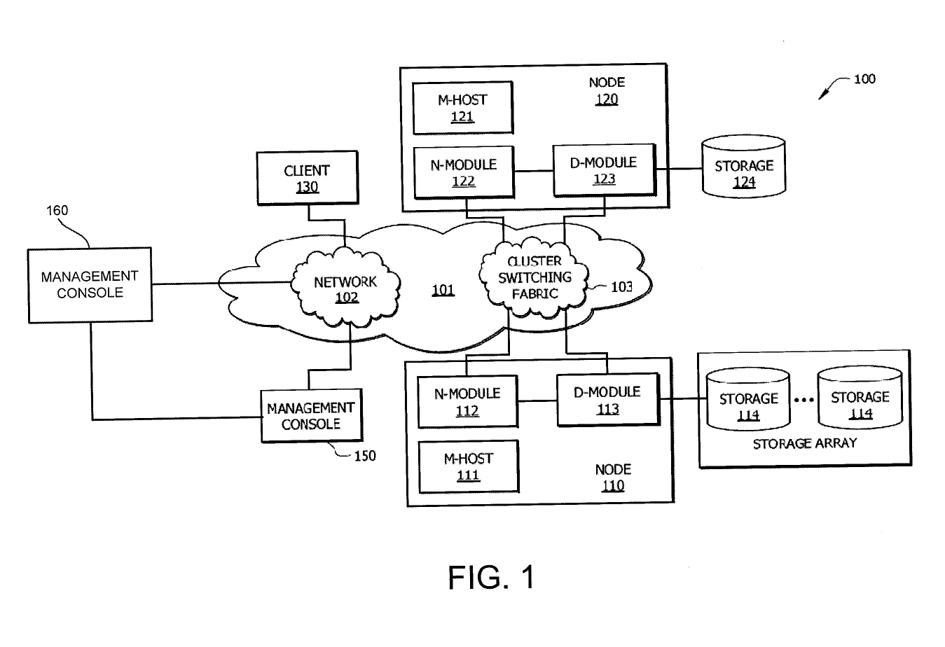

FIG. 1 provides a block diagram of a storage system 100 in accordance with an embodiment of the present disclosure. System 100 includes a storage cluster having multiple nodes 110 and 120 which are adapted to communicate with each other and any additional node of the cluster. Nodes 110 and 120 are configured to provide access to data stored on a set of storage devices (shown as storage devices 114 and 124) constituting storage of system 100. Storage services may be provided by such nodes implementing various functional components that cooperate to provide a distributed storage system architecture of system 100. Additionally, one or more storage devices, such as storage array 114, may act as a central repository for storage system 100. It is appreciated that embodiments may have any number of edge nodes such as multiple nodes 110 and/or 120. Further, multiple storage arrays 114 may be provided at the multiple nodes 110 and/or 120 which provide resources for mirroring a primary storage data set.

Illustratively, nodes (e.g. network-connected devices 110 and 120) may be organized as one or more network elements (N-modules 112 and 122) and/or storage elements (D-modules 113 and 123) and a management element (M-host 111 and 121). N-modules may include functionality to enable nodes to connect to one or more clients (e.g. network-connected device 130) over computer network 101, while D-modules may connect to storage devices (e.g. as may implement a storage array). M-hosts may provide cluster communication services between nodes for generating information sharing operations and for presenting a distributed file system image for system 100. Functionality for enabling each node of a cluster to receive name and object data, receive data to be cached, and to communicate with any other node of the cluster may be provided by M-hosts adapted according to embodiments of the disclosure.

It should be appreciated that network 101 may comprise various forms, and even separate portions, of network infrastructure. For example, network-connected devices 110 and 120 may be interconnected by cluster switching fabric 103 while network-connected devices 110 and 120 may be interconnected to network-connected device 130 by a more general data network 102 (e.g. the Internet, a LAN, a WAN, etc.).

It should also be noted that while there is shown an equal number of N- and D-modules constituting illustrated embodiments of nodes, there may be a different number and/or type of functional components embodying nodes in accordance with various embodiments of the present disclosure. For example, there may be multiple N-modules and/or D-modules interconnected in system 100 that do not reflect a one-to-one correspondence between the modules of network-connected devices 110 and 120. Accordingly, the description of network-connected devices 110 and 120 comprising one N- and one D-module should be taken as illustrative only and it will be understood that the novel technique is not limited to the illustrative embodiment discussed herein.

Network-connected device 130 may be a general-purpose computer configured to interact with network-connected devices 110 and 120 in accordance with a client/server model of information delivery. To that end, network-connected device 130 may request the services of network-connected devices 110 and 120 by submitting a read or write request to the cluster node comprising the network-connected device. In response to the request, the node may return the results of the requested services by exchanging information packets over network 101. Network-connected device 130 may submit access requests by issuing packets using application-layer access protocols, such as the Common Internet File System (CIFS) protocol, Network File System (NFS) protocol, Small Computer Systems Interface (SCSI) protocol encapsulated over TCP (iSCSI), SCSI encapsulated over Fibre Channel (FCP), and SCSI encapsulated over Fibre Channel over Ethernet (FCoE) for instance.

System 100 may further include a management console (shown here as management console 150) for providing management services for the overall cluster. Management console 150 may, for instance, communicate with network-connected devices 110 and 120 across network 101 to request operations to be performed at the cluster nodes comprised of the network-connected devices, and to request information (e.g. node configurations, operating metrics) from or provide information to the nodes. In addition, management console 150 may be configured to receive inputs from and provide outputs to a user of system 100 (e.g. storage administrator) thereby operating as a centralized management interface between the administrator and system 100. In the illustrative embodiment, management console 150 may be networked to network-connected devices 110-130, although other embodiments of the present disclosure may implement management console 150 as a functional component of a node or any other processing system connected to or constituting system 100.

Management console 150 may also include processing capabilities and code which is configured to control system 100 in order to allow for management and monitoring of the network-connected devices 110-130. For example, management console 150 may be configured with a storage management platform, such as SCOM, to perform management of network-connected devices 110-130. In some embodiments, management console 150 may include functionality to serve as a management server within SCOM to monitor different data objects of the network-connected devices 110-130. Within a storage management platform environment, management console 150 may include processing capabilities to serve as a management server or as a management database, which may include a history of alerts, for the storage management platform environment. For additional management resources, system 100 may also include other management consoles 160 in communication with the network-connected devices 110-130 and management console 150.

In a distributed architecture, network-connected device 130 may submit an access request to a node for data stored at a remote node. As an example, an access request from network-connected device 130 may be sent to network-connected device 120 which may target a storage object (e.g. volume) on network-connected device 110 in storage 114. This access request may be directed through network-connected device 120 due to its proximity (e.g. it is closer to the edge than a device such as network-connected device 110) or ability to communicate more efficiently with device 130. To accelerate servicing of the access request and optimize cluster performance, network-connected device 120 may cache the requested volume in local memory or in storage 124. For instance, during initialization of network-connected device 120 as a cluster node, network-connected device 120 may request all or a portion of the volume from network-connected device 110 for storage at network-connected device 120 prior to an actual request by network-connected device 130 for such data.

As can be appreciated from the foregoing, in order to operate as a cluster (e.g. the aforementioned data storage system), network-connected devices 110-130 may communicate with each other. Such communication may include various forms of communication (e.g. point-to-point or unicast communication, multicast communication, etc.). Such communication may be implemented using one or more protocols such as CIFS protocol, NFS, iSCSI, FCP, FCoE, and the like. Accordingly, to effectively cooperate to provide desired operation as a logical entity, each node of a cluster is provided with the capability to communicate with any and all other nodes of the cluster according to embodiments of the disclosure.

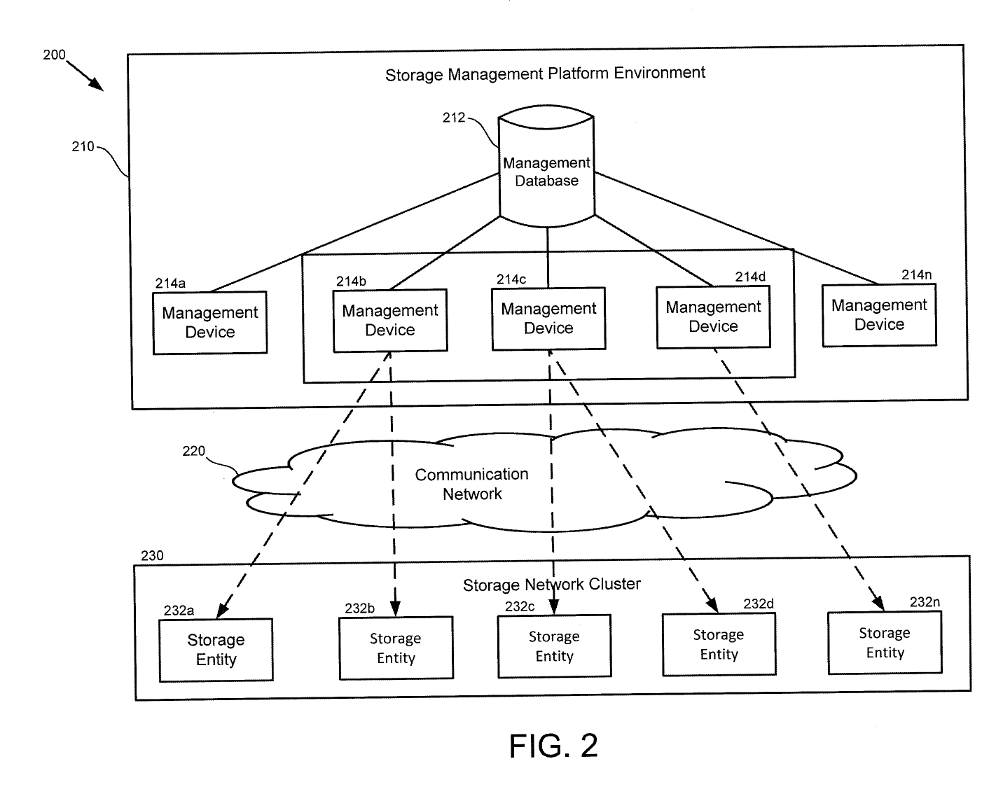

FIG. 2 illustrates a block diagram of storage system 200 in accordance with an embodiment of the present disclosure. System 200 includes a management database 212 and a plurality of management servers 214a-214n within a storage management platform environment 210. The storage management platform environment 210 may be, in some embodiments, SCOM, while in other embodiments a different storage platform environment. In some embodiments, the storage management platform environment 210 may also include functionality for configuring the management servers 214a-214n. A management server 214 may be a computer, a management device with computer processor functionality, or any other processing system capable of monitoring different objects, such as volumes, disks, data, and the like. Referring back to FIG. 1, management database 212 and management servers 214a-214n, may each be a management console 150 or 160. System 200 may also include a communication network 220, and at least one storage network cluster 230. The storage network cluster 230 may include a plurality of storage entities 232a-232n. In some embodiments, a storage entity 232a-232n may be a physical storage entity, while in other embodiments, a storage entity 232a-232n may be a virtual storage entity. In yet another embodiment, a storage entity may be the cluster 230 of storage entities 232a-232n that includes one or more physical storage entities and/or one or more virtual storage entities. Referring back to FIG. 1, communication network 220 may correspond to network 101, and storage network cluster 230 may correspond to nodes 110 and 120.

According to an embodiment, the management devices 214a-214n may communicate with the storage network cluster 230 and the storage entities 232a-232n via the communication network 220. Communication network 220 may include any type of network such as a cluster switching fabric, the Internet, WiFi, mobile communications networks such as GSM, CDMA, 3G/4G, WiMax, LTE and the like. Further communication network 220 may comprise a combination of network types working collectively.

In one embodiment, the network cluster 230 comprising a plurality of storage entities 232a-232n may be managed by a management server 214, while in another embodiment, a storage entity 232 within cluster 230 may be individually managed by a management server 214. In yet another embodiment, a plurality of storage entities 232a-232n may be managed by a group of management devices 216 within the storage management platform environment 210. In embodiments, group 16 may include at least two management devices 214b-214c, while in other embodiments, group 16 may include more than two management devices 214b-214d, as shown in FIG. 2. In some embodiments, each management server 214b-214d within the group of management servers 216 may be configured to individually manage at least a subset of the plurality of storage entities 232a-232n in the storage cluster 230. In other embodiments, at least one management server 214b-214d within the group of management servers 216 may be configured to individually manage at least a subset of the plurality of storage entities 232a-232n in the storage cluster 230. The subset of the plurality of storage entities 232a-232n that may be monitored by a management server 214 may include one or more storage entities 232.

In some embodiments, each management server 214b-214d within the group of management servers 216 may also be configured to have access to management database 212 and/or to each of the other management devices 214b-214d in the group 216. In other embodiments, at least one management server 214b-214d within the group of management servers 216 may be configured to have access to the management database 212 and/or to another management device 214b-214d in the group 216. With access to a management database 212, or another management server in the group 216, a management server 214b-214d may communicate with and/or share data with the management database 212 or another management server in the group 216. For example, in some embodiments a management device 214 with access to the management database 212 may receive instructions from the shared management database 212 to manage the plurality of storage entities 232a-232n. According to an embodiment, the management database 212 may be a separate management device than management devices 214, while in other embodiments the management database 212 may be a management device 214, either within the group 216 or not, or more than one management devices 214a-214n.

In an embodiment, each storage entity 232 may be manageable by any one management device 214 of the group 216. In other embodiments, a subset of the storage entities 232 may be manageable by any one management device 214 of the group 216. Therefore, in some embodiments, each storage entity 232 may be managed by one management device 214 of the group 216 at a given time. According to another embodiment, each storage entity 232 may be managed by more than one management device 214 of the group 216 at a given time.

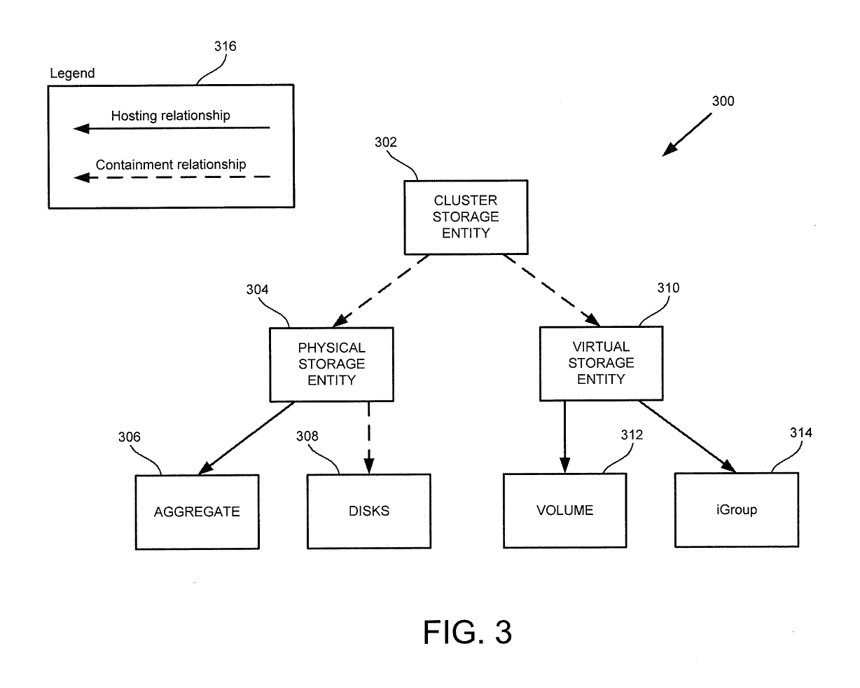

According to an embodiment, the group 216 of management devices 214b-214d may be deployed to manage the plurality of storage entities 232a-232n of the storage network cluster 230. Prior to managing the storage entities 232a-232n as a group 216, the management devices 214b-214d of the group 216 may identify a storage entity hierarchy for the plurality of storage entities 232a-232n. FIG. 3 shows a block diagram illustrating a storage entity hierarchy 300 for the plurality of storage entities 302-314 in accordance with an embodiment of the present disclosure. The storage entity hierarchy 300 may define the storage entity hierarchy 300 for any storage entity 232a-232n in FIG. 2. As an example, storage entity hierarchy 300 may correspond to the storage entity hierarchy for storage entity 232a. According to an embodiment, the storage entity hierarchy 300 may define the relationships between the storage entities 302-314 in the storage network, such as storage network cluster 230 of FIG. 2. In FIG. 3, aggregate 306 and disks 308 may be different types of physical storage entities, and volume 312 and iGroup 314 may be different types of virtual storage entities. The relationships defined in storage entity hierarchy 300 may specify which storage entities are hosted and which storage entities are contained, as shown in legend 316. A hosting relationship may be one in which an object cannot exist without its parent object, and therefore may define a one-to-one mapping, such as a relationship between a child and parent because a child can only have one biological mother or father. A containment relationship may be one in which objects are related to each other, although one may not be required for the other to exist and therefore may define a many-to-many mapping. According to the embodiment illustrated in FIG. 3, a virtual storage entity 310 and a volume 312 may have a hosting relationship, whereas a physical storage entity 304 and a disk 308 may have a containment relationship.

In some embodiments, once a management device 214b within a group identifies the storage entity hierarchy 300 for the plurality of storage entities 232a-232n, that particular management device 214b may become eligible to be included as part of the group 216 used to manage the plurality of storage entities. Therefore, in some embodiments, management of the plurality of storage entities 232a-232n with the group of management devices 214b-214d may be performed in accordance with the identified storage entity hierarchy 300. According to one embodiment, a management device 214d not having identified the storage entity hierarchy 300 for the plurality of storage entities 232a-232n may not be eligible for inclusion as part of the group of management devices 216 used to manage the plurality of storage entities 232a-232n. As an example, management devices 214b-214d may be deployed as a group of management devices 216 to manage the plurality of storage entities 232a-232n. If management devices 214b and 214c have identified the storage entity hierarchy 300 for the plurality of storage entities 232a-232n and management device 214d has not, then management of the plurality of storage entities 232a-232n may be distributed across management devices 214b-214c, but not management device 214d even though management device 214d has been specified to be part of group 216. When system 200 has configured management device 214d to identify the storage entity hierarchy 300 for the plurality of storage entities 232a-232n, then management of the plurality of storage entities 232a-232n may be distributed across each of management devices 214b-214d in the group 216.

Without being designated as part of a group of management devices 216 and having the functionality to identify the storage entity hierarchy 300, a management device may not be able to be included as part of the group of management devices 216 that manages a plurality of storage entities 232a-232n. For example, management servers 214a and 214n have neither been designated as part of the group 216, nor have they been given the functionality to identify the storage entity hierarchy, and therefore neither management server 214a nor 214n may be included within the group 216 that manages the plurality of storage entities.

In addition to managing the plurality of storage entities 232a-232n in accordance with the identified storage entity hierarchy 300, the management of the plurality of storage entities may also be based, at least in part, on a determined load and/or health of a management device 214b-214d of the group of management devices 216. For example, system 200 may be configured to determine a load associated with a management device 214b of the group of management devices 216. According to some embodiments, the load associated with a management device 214 may provide information related the number of storage entities 232a-232n being managed by the management device 214, the number of data objects being monitored by the management device 214, the amount of I/O traffic that is directed to or from the management device 214, or any other parameter which consumes processing resources of a management server 214. In other embodiments, the load parameter may also provide information related to the percentage of processing resources of a management device 214 are being consumed.

With the load determined, system 200 may include functionality to determine if the load associated with management device 214b of the group of management devices 216 has reached or is near a maximum capacity. If the load associated with management device 214b is determined to have reached or be near the maximum capacity, the management of the plurality of storage entities 232a-232n by the group of management devices 216 may be redistributed across the group 216 to balance the load associated with at least the first management device 214b in the group 216. In some embodiments, balancing the loads of the management devices 214b-214d of the group 216 may include removing the management responsibility of the first management device 214b for a first storage entity 232a, and managing the first storage entity by a second management device 214c in the group 216 that has available load capacity to manage one or more additional storage entities 232a-232n. As an example, in some embodiments, each storage entity 232a-232n may have an identifier associated with it that specifies which management device 214b-214d from the group 216 is managing it. Therefore, according to one embodiment, removing the management responsibility of the first management device 214b for the first storage entity 232a may include clearing the identifier associated with the first storage entity 232a. In addition, managing the first storage entity 232a by a second management device 214c may include updating the identifier associated with the first storage entity 232a that indicates which management device 214b-214d from the group 216 is managing the first storage entity 232a to indicate that the second management device 214c is now managing the first storage entity 232a.

As an example of balancing the load associated with at least one management device in the group 216, if one management device 214c of the group 216 is at 20% capacity and another management device 214d is at 95% capacity, then management of the storage entities 232a-232n may be redistributed among the group 216 such that management device 214c is at 60% capacity and management device 214d is at 55% capacity. As another example, if a management device 214c of the group 216 is managing 300 storage entities, which in some embodiments may be near the maximum capacity for a management device, then management of the storage entities 232a-232n may be redistributed among the group 216 such that management device 214c is now managing 20 storage entities.

In some embodiments, the storage entity hierarchy 300 for the plurality of storage entities 232a-232n may be defined to designate which storage entities 232a-232n in the storage network cluster 230 may be used to balance the load associated with at least one management device 214b-214d of the group 216. For example, in an embodiments, the storage entity hierarchy 300 may designate that top level unhosted storage entities may be used for load balancing. According to the embodiment, a storage entity 232a may be used for load balancing if the storage entity 232a is unhosted and there is no hosted storage entity in its path to the top most level. For example, according to the embodiment of FIG. 3, a physical storage entity 304, a virtual storage entity 310, and a disk 308, may all be used for load balancing, but aggregate 306, volume 312, and iGroup 314 may not be used for load balancing because they are each hosted in the storage entity hierarchy 300. Even if, for example, volume 312 contained an object at a lower level, thereby designating a containment relationship between the volume 312 and the object, the object may not be able to be used for load balancing because volume 312 is hosted, even though the object is unhosted. Therefore, in some embodiments, the identified storage entity hierarchy 300 may be the storage entity hierarchy 300 that defines which storage entities 232a-232n in the storage network cluster 230 may be used to balance the load associated with at least one management device 214b-214d of the group 216.

According to another embodiment, system 200 may include functionality to determine a health associated with a management device 214b of the group of management devices 216. In one embodiment, the health of a management device 214 may provide information detailing whether the management device 214 is properly managing and monitoring storage entities 232, is operating at a high performance level, has software bugs or viruses, is secure, is up-to-date, and the like. In one embodiment, determining the health of a management device 214 may include monitoring a plurality of conditions associated with the management device 214 that indicate that the management device 214 is healthy. In some embodiments, the conditions may be user-defined and modifiable.

With the health determined, system 200 may also include functionality to determine if management device 214b is not healthy based, at least in part, on the determined health associated with management device 214b. Determining that a management device 214 is not healthy may, according to one embodiment, include detecting, through monitoring of the management device 214, that a condition indicating a healthy management device 214 is not met. For example, according to one embodiment, a management device 214 may be determined to be not healthy if a condition requiring that the management device 214 monitor a particular storage entity is not met. That is, the monitoring of the management device 214 may detect that the management device 214 is not performing any management of any storage entities even though it has been configured to monitor particular devices, which may be an indication that the management device 214 is not healthy. In another embodiment, a management device 214 may be determined to be not healthy if it is detected, through monitoring of the management device 214, that the account credentials associated with the management device are out-of-date or incorrect. In some embodiments, monitoring of the management device 214 may indicate that all healthy conditions are met by the management device, which may indicate that the management device is healthy.

If the first management device 214b is determined to not be healthy, the management of the plurality of storage entities 232a-232n by the group of management devices 216 may be redistributed across the group 216. For example, if the first management device 214b is determined to not be healthy, the management responsibility of the first management device 214b for a first storage entity 232a may be removed, and a second management device 214c in the group 216 may be designated to manage the first storage entity 232a, where the second management device is a healthy management device 214. For example, according to one embodiment, removing the management responsibility of the first management device 214b for the first storage entity 232a may include clearing the identifier associated with the first storage entity 232a. In addition, designating a second management device 214c to manage the first storage entity 232a may include updating the identifier associated with the first storage entity 232a that indicates which management device 214b-214d from the group 216 is managing the first storage entity 232a to indicate that the second management device 214c is now managing the first storage entity 232a.

As in the case for load balancing, in some embodiments, the storage entity hierarchy 300 for the plurality of storage entities 232a-232n may be defined to designate which storage entities 232a-232n in the storage network cluster 230 may be managed by a first and a second management device. Therefore, in some embodiments, the storage entity hierarchy 300 identified prior to managing the plurality of storage entities 232a-232n with the group 216 may be the storage entity hierarchy 300 that defines which storage entities 232a-232n in the storage network cluster 230 may be managed by a first 214b and a second management device 214c of the group 216.

In some embodiments, managing a storage entity 232 with a management device 214 may include monitoring different objects of a storage entity 232, such as a network connection, data, such as directories, shared folders, software, and the like. These objects may, in some embodiments, be monitored and used to provide information regarding the load, operation, health, and the like of the storage entity 232 and a management device 214 monitoring the storage entity 232. In other embodiments, objects monitored by a management device may also include events or alerts occurring at the storage entities 232a-232n. In some aspects, a determination of the load associated with a storage entity 232 or a management device 214 may be made based on the monitored objects.

In view of exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

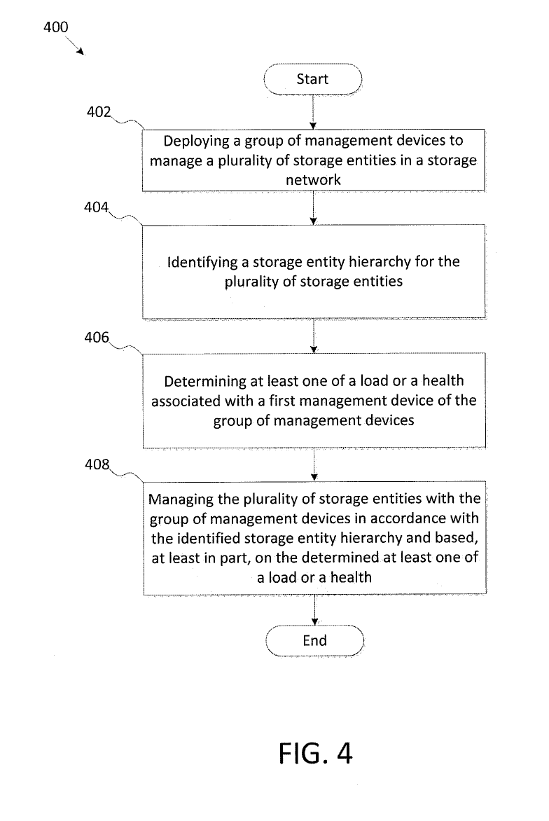

FIG. 4 illustrates a method 400 for managing storage entities in a storage network in accordance with an embodiment of the present application. It is noted that embodiments of method 400 may be implemented with the systems described above with respect to FIGS. 1-3. Specifically, method 400 of the illustrated embodiment includes, at block 402, deploying a group of management devices to manage a plurality of storage entities in a storage network. In some embodiments, each management device of the group may have access to a shared management database, and the group may include at least two management devices. The group of management devices and the plurality of storage entities may include the group of management devices and the storage entities described above with respect to FIGS. 1-3. Method 400, as shown in FIG. 4, also includes, at block 404, identifying a storage entity hierarchy for the plurality of storage entities. In embodiments, the identified storage entity hierarchy may define a relationship between the storage entities in the storage network to designate which storage entities may be used for load balancing or which storage entities may be managed by at least two management devices.

Method 400 of the illustrated embodiment further includes, at block 406, determining at least one of a load or a health associated with a first management device of the group of management devices. Method 400 also includes, at block 408, managing the plurality of storage entities with the group of management devices in accordance with the identified storage entity hierarchy and based, at least in part, on the determined at least one of a load or a health. The load and/or health may provide information associated with a management device as described above with respect to FIGS. 1-3.

The schematic flow chart diagram of FIG. 4 is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer-readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some embodiments different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Those of skill would further appreciate that the various illustrative logical blocks, modules, circuits, and algorithm steps described in connection with the disclosure herein may be implemented as electronic hardware, computer software stored on a computing device and executed by one or more processing devices, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

It is also appreciated that the systems and method described herein are able to be scaled for larger storage network systems. For example, a cluster may include hundreds of nodes, multiple virtual servers which service multiple clients and the like. Furthermore, the systems and method described herein should not be read as applicable to only one specific type of storage management platform, such as SCOM, as the systems and method described herein are applicable to other storage management platforms as well. Such modifications may function according to the principles described herein.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for managing storage entities in a storage network, the method comprising:
deploying a group of management devices to manage a plurality of storage entities in the storage network, each management device of the group having access to a shared management database, wherein the group comprises at least two management devices;
identifying a storage entity hierarchy for the plurality of storage entities;
determining at least one of a load or a health associated with a first management device of the group of management devices; and
managing the plurality of storage entities with the group of management devices in accordance with the identified storage entity hierarchy and based, at least in part, on the determined at least one of a load or a health, wherein managing the plurality of storage entities comprises distributing the management of the plurality of storage entities across the group of management devices.

2. The method of claim 1, further comprising:
determining if the determined load associated with the first management device has reached or is near a maximum capacity; and
balancing the load associated with at least the first management device of the group if the load is determined to have reached or be near the maximum capacity, wherein balancing comprises removing the management responsibility of the first management device for a first storage entity, and managing the first storage entity by a second management device in the group.

3. The method of claim 2, further comprising defining the storage entity hierarchy to designate which storage entities in the storage network may be used to balance the load associated with at least the first management device of the group, wherein identifying a storage network hierarchy comprises identifying the defined storage entity hierarchy.

4. The method of claim 3, wherein defining the storage entity hierarchy comprises defining a relationship between the storage entities in the storage network to specify which storage entities are hosted and which storage entities are contained, wherein storage entities that may be used for balancing comprise storage entities that are not hosted.

5. The method of claim 1, further comprising:
determining if the first management device is not healthy based, at least in part, on the determined health associated with the first management device; and
redistributing the management of the plurality of storage entities across the group of management devices if the first management device is determined to not be healthy, wherein redistributing comprises removing the management responsibility of the first management device for a first storage entity, and managing the first storage entity by a second management device in the group, wherein the second management device is healthy.

6. The method of claim 5, further comprising defining the storage entity hierarchy to designate which storage entities in the storage network may be managed by the first and the second management device, wherein identifying a storage network hierarchy comprises identifying the defined storage entity hierarchy.

7. The method of claim 6, wherein defining the storage entity hierarchy comprises defining a relationship between the storage entities in the storage network that specifies which storage entities are hosted and which storage entities are contained.

8. The method of claim 1, further comprising receiving instructions from the shared management database to manage the plurality of storage entities.

9. The method of claim 1, wherein the shared management database comprises at least one management device of the group of management devices.

10. A system operable with a storage network, the system comprising:
a group comprised of at least two management devices to manage a plurality of storage entities in the storage network; and
at least one processing module configured to:
configure each management device of the group to have access to a shared management database;
identify a storage entity hierarchy for the plurality of storage entities;
determine at least one of a load or a health associated with a first management device of the group of management devices; and
manage the plurality of storage entities with the group of management devices in accordance with the identified storage entity hierarchy and based, at least in part, on the determined at least one of a load or a health, wherein managing the plurality of storage entities comprises distributing the management of the plurality of storage entities across the group of management devices.

11. The system of claim 10, wherein the at least one processing module is further configured to:
determine if the determined load associated with the first management device has reached or is near a maximum capacity; and
balance the load associated with at least the first management device of the group if the load is determined to have reached or be near the maximum capacity, wherein balancing comprises removing the management responsibility of the first management device for a first storage entity, and managing the first storage entity by a second management device in the group.

12. The system of claim 11, wherein the at least one processing module is further configured to define the storage entity hierarchy to designate which storage entities in the storage network may be used to balance the load associated with at least the first management device of the group, wherein identifying a storage network hierarchy comprises identifying the defined storage entity hierarchy.

13. The system of claim 12, wherein defining the storage entity hierarchy comprises configuring the at least one processing module to define a relationship between the storage entities in the storage network to specify which storage entities are hosted and which storage entities are contained, wherein storage entities that may be used for balancing comprise storage entities that are not hosted.

14. The system of claim 10, wherein the at least one processing module is further configured to:
determine if the first management device is not healthy based, at least in part, on the determined health associated with the first management device; and
redistribute the management of the plurality of storage entities across the group of management devices if the first management device is determined to not be healthy, wherein redistributing comprises removing the management responsibility of the first management device for a first storage entity, and managing the first storage entity by a second management device in the group, wherein the second management device is healthy.

15. The system of claim 14, wherein the at least one processing module is further configured to define the storage entity hierarchy to designate which storage entities in the storage network may be managed by the first and the second management device, wherein identifying a storage network hierarchy comprises identifying the defined storage entity hierarchy.

16. The system of claim 15, wherein defining the storage entity hierarchy comprises configuring the at least one processing module to define a relationship between the storage entities in the storage network that specifies which storage entities are hosted and which storage entities are contained.

17. The system of claim 10, wherein the at least one processing module is further configured to receive instructions from the shared management database to manage the plurality of storage entities.

18. The system of claim 10, wherein the shared management database comprises at least one management device of the group of management devices.

19. A computer program product, comprising:
a non-transitory computer-readable medium comprising code for causing a computer to:
configure each management device of a group to have access to a shared management database, wherein the group comprises at least two management devices;
identify a storage entity hierarchy for a plurality of storage entities;
determine at least one of a load or a health associated with a first management device of the group of management devices; and
manage the plurality of storage entities with the group of management devices in accordance with the identified storage entity hierarchy and based, at least in part, on the determined at least one of a load or a health, wherein managing the plurality of storage entities comprises distributing the management of the plurality of storage entities across the group of management devices.

20. The computer program product of claim 19, further comprising code for causing the computer to:
determine if the determined load associated with the first management device has reached or is near a maximum capacity; and
balance the load associated with at least the first management device of the group if the load is determined to have reached or be near the maximum capacity, wherein balancing comprises removing the management responsibility of the first management device for a first storage entity, and managing the first storage entity by a second management device in the group.

21. The computer program product of claim 20, further comprising code for causing the computer to define the storage entity hierarchy to designate which storage entities in the storage network may be used to balance the load associated with at least the first management device of the group, wherein identifying a storage network hierarchy comprises identifying the defined storage entity hierarchy.

22. The computer program product of claim 21, wherein defining the storage entity hierarchy comprises code for causing the computer to define a relationship between the storage entities in the storage network to specify which storage entities are hosted and which storage entities are contained, wherein storage entities that may be used for balancing comprise storage entities that are not hosted.

23. The computer program product of claim 19, further comprising code for causing the computer to:
determine if the first management device is not healthy based, at least in part, on the determined health associated with the first management device; and
redistribute the management of the plurality of storage entities across the group of management devices if the first management device is determined to not be healthy, wherein redistributing comprises removing the management responsibility of the first management device for a first storage entity, and managing the first storage entity by a second management device in the group, wherein the second management device is healthy.

24. The computer program product of claim 23, further comprising code for causing the computer to define the storage entity hierarchy to designate which storage entities in the storage network may be managed by the first and the second management device, wherein identifying a storage network hierarchy comprises identifying the defined storage entity hierarchy.

25. The computer program product of claim 24, wherein defining the storage entity hierarchy comprises configuring the at least one processing module to define a relationship between the storage entities in the storage network that specifies which storage entities are hosted and which storage entities are contained.

26. The computer program product of claim 19, further comprising code for causing the computer to receive instructions from the shared management database to manage the plurality of storage entities.

27. The computer program product of claim 19, wherein the shared management database comprises at least one management device of the group of management devices.
